(19) United States
(12) Patent Application Publication
(10) Pub. No.: US 2010/0304847 A1
(43) Pub. Date: Dec. 2, 2010

(54) WIN DISTRIBUTION FOR A GAMING MACHINE AND METHOD OF GAMING

(76) Inventor: Paul Bramble, Artarmon NSW (AU)

Correspondence Address: MCANDREWS HELD & MALLOY, LTD, 500 WEST MADISON STREET, SUITE 3400, CHICAGO, IL, 60661, US

(21) Appl. No.: 12/782,239

(22) Filed: May 18, 2010

(30) Foreign Application Priority Data
May 26, 2009 (AU) 2009902403

(51) Int. Cl. A63F 9/24; A63F 13/00

(52) U.S. Cl. 463/25; 463/30

(57) ABSTRACT

A wagering game on a gaming machine (100) is described. A paytable (7) provides a plurality of different possible awards for game play on the gaming machine (100), with at least one of the possible awards being a negative award. A negative award results in a reduction in a credit balance in addition to any wager that may have been staked for the game play.

### RELATED APPLICATIONS

This application claims priority to Australian Application No. 2009902403, having a filing date of May 26, 2009, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to gaming machines and methods of gaming.

With the increase of gambling at gaming venues has come increased competition between gaming venues to obtain a larger share of the total gambling spend. Gaming venue operators have therefore continuously looked for new variations and types of games in order to attract both new and return customers to their venues.

In response to this need, suppliers of gaming devices and systems have attempted to provide the sought after variety, while still developing games that comply with the relevant regulations in the jurisdiction of the gaming venue operator. Suppliers of gaming devices therefore are faced with restrictions on the types of games and gaming machines that are allowable, both in terms of the prevailing regulations and in terms of providing a return on investment to the gaming venue operators.

Many jurisdictions specify a particular minimum return to player that a gaming machine must have. For example, a jurisdiction may specify a minimum average return to player of 85%. Gaming machines are therefore designed to exceed this minimum average required return to player, while still in the medium to long term provide an adequate return on investment to the gaming venue operator. Providing a return to gaming venue operators requires that players lose money over time. However, the perception of excessive losses on a gaming machine can detract from the entertainment value of game play.

### BRIEF SUMMARY OF THE INVENTION

According to one aspect of the invention, there is provided a method of providing a wagering game implemented using a gaming machine, the method including determining an outcome of a game play of the wagering game, displaying representations of the outcome on a display of the gaming machine and awarding an award for the game play dependent on the determined outcome, wherein there are a plurality of different possible awards for the game play and at least one of the possible awards is a negative award, which results in a reduction in a credit balance in addition to any wager that may have been staked for the game play.

According to another aspect of the invention, there is provided a method of providing a wagering game implemented using a gaming machine, the method including determining an outcome of a game play of the wagering game, displaying representations of the outcome on a display of the gaming machine and awarding an award for the game play dependent on the determined outcome, wherein there are a plurality of different possible awards for the game play and at least one of the possible awards is a negative award, which results in a reduction in a credit balance, and wherein the method includes providing as at least one wager that is able to be staked in the game a negative value wager, which when staked results in an increase in value of a credit meter of the gaming machine.

According to another aspect of the invention, there is provided a gaming machine that provides a wagering game by determining an outcome of a game play of the wagering game, displaying representations of the outcome on a display and awards an award for the game play dependent on the determined outcome, wherein there are a plurality of different possible awards for the game play and at least one of the possible awards is a negative award, which results in a reduction in a credit balance in addition to any wager that may have been staked for the game play.

According to another aspect of the invention, there is provided a gaming machine that provides a wagering game, the gaming machine including a game controller that determines an outcome of a game play of the wagering game, causes the display of representations of the outcome on a display and awards an award for the game play dependent on the determined outcome, wherein there are a plurality of different possible awards for the game play and at least one of the possible awards is a negative award, which results in a reduction in a credit balance and wherein a player is able to stake a zero-value wager to commence game play.

According to another aspect of the invention, there is provided a gaming machine that provides a game in which a plurality of symbols are selected and presented on a display and if a winning combination occurs, the gaming machine awards an award, the gaming machine including a user interface in communication with a game controller that determines an outcome of a game play of the wagering game, displays representations of the outcome on the display and causes the award of an award dependent on the determined outcome, wherein there are a plurality of different possible awards for the game play and at least one of the possible awards is a negative award, which results in a reduction in a credit balance, and wherein a negative value wager is required to play a game play of the wagering game.

According to another aspect of the invention, there is provided a gaming machine that provides a wagering game by determining an outcome of a game play of the wagering game, displaying representations of the outcome on a display and awards an award for the game play dependent on the determined outcome, wherein there are a plurality of different possible awards for the game play and at least one of the possible awards is a negative award, which is awarded to a win meter and which if transferred to the credit meter results in a reduction in a credit balance in addition to any wager that may have been staked for the game play and wherein the wagering game includes a further game event that affects the value held in the win meter after a said award has been made to the win meter.

According to another aspect of the invention, there is provided a gaming machine that provides a game in which a plurality of symbols are selected and presented on a display and if a winning combination occurs, the gaming machine awards an award, the gaming machine including a user interface in communication with a game controller that determines an outcome of a game play of the wagering game using one or more random numbers from a random number generator, controls the display to display representations of the outcome and causes the award of an award dependent on the determined outcome, wherein there are a plurality of different possible awards for the game play and at least one of the possible awards is a negative award, which results in a reduction in a credit balance in addition to any wager that may have been staked for the game play, and the method includes providing the wagering game to have a return to player of less than 100% and to have at least a 50% chance that the determined outcome results in the award of a said award that is greater than the return of the wagering game.

According to a further aspect of the invention, there is provided instructions for a computational device stored in memory in communication with the computational device or as part of the computational device, wherein the instructions cause the computation device to perform either of the methods described in the preceding paragraphs.

Further aspects of the present invention will be apparent from the following description, given by way of example and with reference to the accompanying drawings. Also, various embodiments of the aspects described in the preceding paragraphs will be apparent from the appended claims, the following description and/or the accompanying drawings.

### BRIEF DESCRIPTION OF SEVERAL VIEWS OF THE DRAWINGS

FIG. 1: shows diagrammatically, a view of a gaming console suitable for implementing the present invention.

FIG. 2: shows a block diagram of gaming machine suitable for implementing the present invention.

FIG. 3: shows a block diagram of components of the memory of the gaming machine represented in FIG. 2.

FIG. 4: shows a flow diagram of a process performed in accordance with an embodiment of the present invention.

FIG. 5: is a graph of a possible distribution of wins according to a known game structure;

FIG. 6: is a graph of an embodiment of a distribution of wins according to an aspect of the present invention.

### DETAILED DESCRIPTION OF THE INVENTION

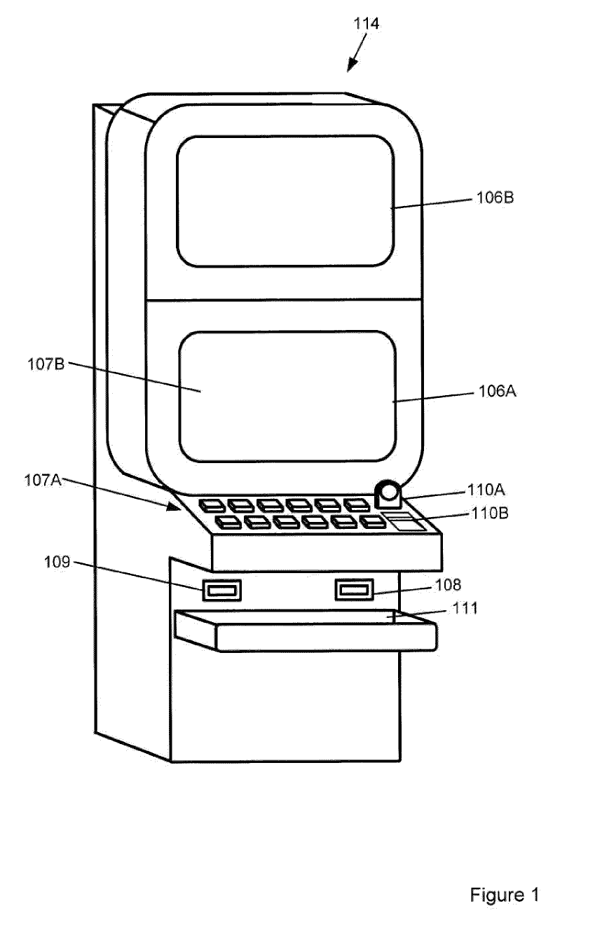

In FIG. 1 of the accompanying drawings, one example of a gaming console that is suitable to implement the present invention is generally referenced by arrow 114.

The gaming console 114 includes two displays 106A, 106B on one or both of which is displayed representations of a game that can be played by a player and a bank of buttons 107A and/or a touch screen 107B to enable a player to play the game. The displays 106 may be video display units, such as a cathode ray tube screen device, a liquid crystal display, plasma screen, any other suitable video display unit, or the visible portion of an electromechanical device. The display 106B may display artwork, including for example, pay tables and details of bonus awards and other information or images relating to the game. In alternative gaming consoles the display 106B may be omitted, optionally replaced by a static display.

A credit input including a coin input 110A and/or bill collector 110B allows a player to provide credit for wagering and a coin output 111 is provided for cash payouts from the gaming console 114. A card and/or ticket reader 108 and a printer 109 may be provided to provide player tracking, cashless game play or other gaming and non-gaming related functions.

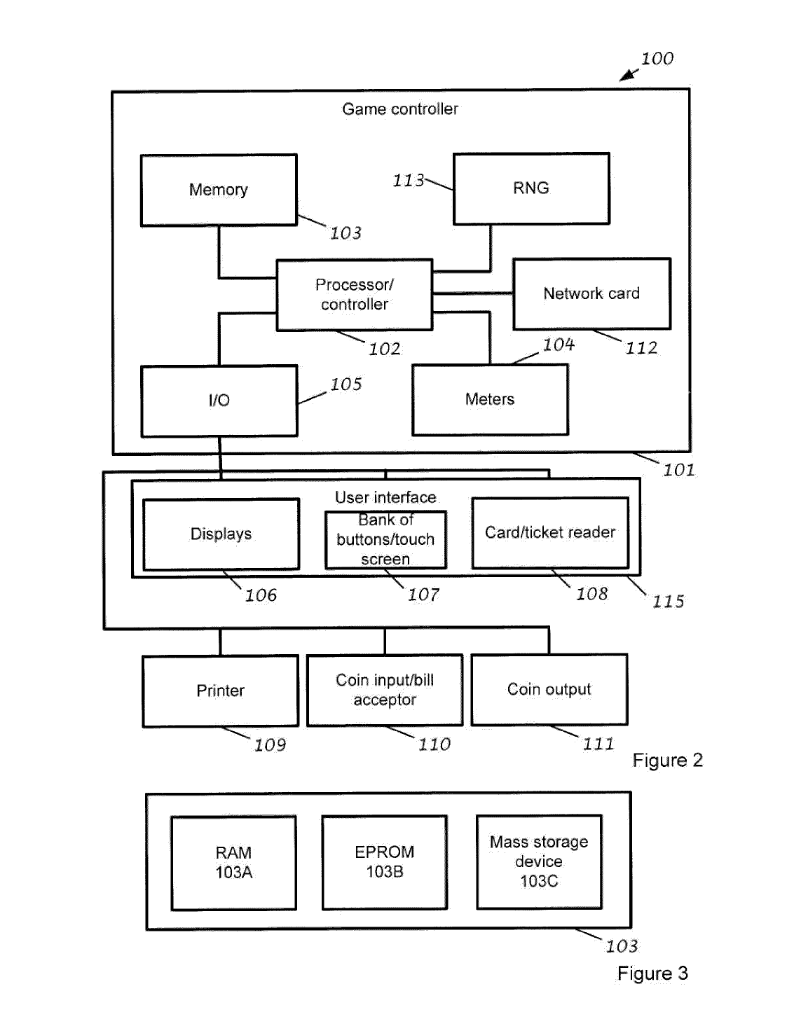

FIG. 2 shows a block diagram of a gaming machine, generally referenced by arrow 100, suitable for implementing the present invention. The gaming machine 100 may include the gaming console 114 shown in FIG. 1 and accordingly like reference numerals have been used to describe like components in FIGS. 1 and 2.

The gaming machine 100 includes a game controller 101, which in the illustrated example includes a computational device 102, which may be a microprocessor, microcontroller, programmable logic device or other suitable device. Instructions and data to control operation of the computational device 102 are stored in a memory 103, which is in data communication with, or forms part of, the computational device 102. Typically, the gaming machine 100 will include both volatile and non-volatile memory and more than one of each type of memory, with such memories being collectively represented by the memory 103. The instructions to cause the game controller 101 to implement the present invention will be stored in the memory 103.

The game controller 101 may include hardware credit meters 104 for the purposes of regulatory compliance and also include an input/output (I/O) interface 105 for communicating with the peripheral devices of the gaming machine 100. The input/output interface 105 and/or the peripheral devices may be intelligent devices with their own memory for instructions and data.

In the example shown in FIG. 2, the peripheral devices that communicate with the controller are the displays 106, bank of buttons/touch screen 107, the card and/or ticket reader 108, the printer 109, a bill acceptor and/or coin input 110 and a coin output 111. Additional devices may be included as part of the gaming machine 100, or devices omitted as required for the specific implementation.

The bank of buttons 107A and/or touch screen 107B together with one or both of the displays 106 may provide a user interface 115 through which the gaming machine 100 and player communicate. If a card/ticket reader 108 is provided, this may also form part of the user interface 115.

In addition, the gaming machine 100 may include a communications interface, for example a network card 112. The network card 112, may for example, send status information, accounting information or other information to a central controller, server or database and receive data or commands from the central controller, server or database. The network card 112 may also enable communication with a central player account, allowing cashless gaming. One or more of the peripheral devices, for example the card/ticket reader 108 may be able to communicate directly with the network card 112. The network card 112 and the I/O interface 105 may be suitably implemented as a single machine communications interface.

The game controller 101 may also include a random number generator 113, which generates a series of random numbers that are used by the computational device 102 to determine the outcomes of games played on the gaming machine 100.

The game controller 101 may have distributed hardware and software components that communicate with each other directly or through a network or other communication channel. The game controller 101 may also be located in part or in its entirety remote from the user interface 115. Also, the computational device 102 may include a plurality of devices, which may be local or remote from each other.

FIG. 3 shows an exemplary block diagram of the main components of the memory 103. The RAM 103A typically temporarily holds instructions and data related to the execution of game programs and communication functions performed by the computational controller 102. The EPROM 103B may be a boot ROM device and/or may contain system and game related code. The mass storage device 103C may be used to store game programs, the integrity of which may be verified and/or authenticated by the computational controller 102 using protected code from the EPROM 103B or elsewhere.

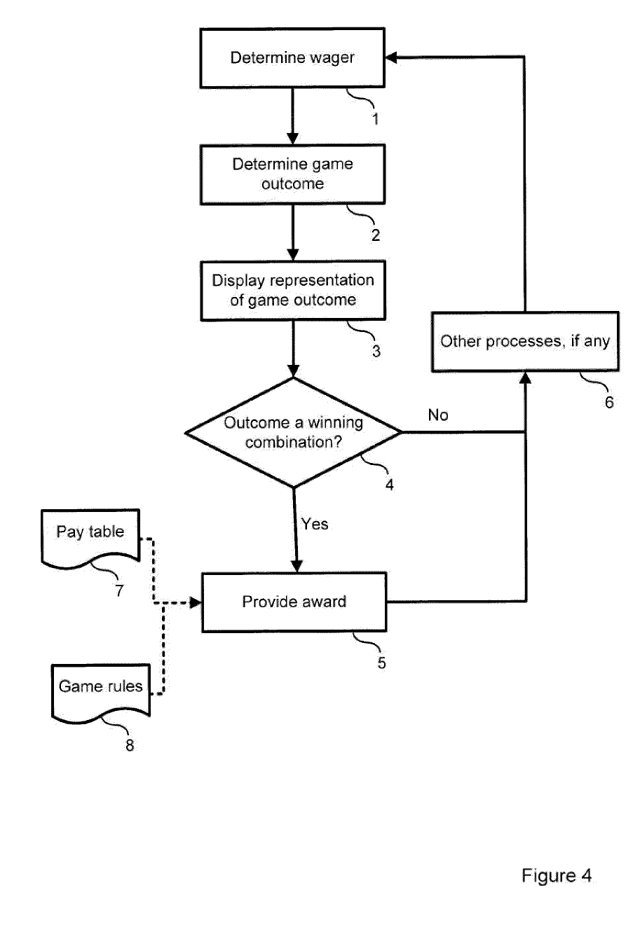

FIG. 4 shows a process flow diagram of a typical game process in which the present invention may be utilised. The process may be performed by the gaming machine 100 described herein and the following description assumes this implementation. However, those skilled in the relevant arts will appreciate that the process will also be able to be implemented by other gaming machines, devices or systems. While the process is described with reference to a specific order of steps, in alternative embodiments the order of the steps may be changed, subject to compliance with the relevant regulations, if any that may apply.

In step 1, the game controller 101 monitors the bill acceptor and/or coin input 110 and/or information received by the card/ticket reader 108 or network card 112 for a deposit of credit and in response causes the credit meters 104 to increment according to the denomination of the game. The game controller 101 then monitors the user interface 107 for the input of a wager.

Once the wager has been determined in step 1 and if there are sufficient credits in the meters 104 to support the wager (see herein below), in one embodiment the game controller 101 decrements the relevant credit meter 104 by the amount of the wager. In other embodiments, as is explained herein below the credit meter 104 is not decremented by any wager amount. In step 2 the gaming controller 101 receives one or more random numbers from the RNG 113 and determines the game outcome based on the received number(s). This may be achieved by examining a look-up table that has a range of numbers within the range of possible numbers that can be generated by the RNG 113 assigned to each available outcome in the game.

In step 3 the game controller 101 controls the display 106 to display images representing the outcome. For example if the game is a spinning reel game, the game controller 101 controls the display to display representations of reels in a stopped position to reveal a plurality symbols. Embodiments of the invention may be implemented as various different types of spinning reel games, card games, dice games, keno games and other games. The games may be stand-alone games, or group play games.

In step 4 the game controller determines whether the outcome results in the award of an award. This is determined from a pay table 7 and from the game rules 8. Taking again the example of a spinning reel game, a combination of three kings appearing along a pay line in the three leftmost reels may be specified in the pay table 7 to pay an award of 18 credits.

If no award is to be made, the process returns to step 1 via any other processes (step 6) that may occur with each game play or on a random basis. For example, the game may involve providing a second chance game or play certain animations between game plays. If an award is to be made, then this is performed in step 5, which for an award paid in credits, typically involves incrementing a win meter by the amount of the award and subsequently increasing the value of the appropriate credit meter 104, optionally with one or more intervening game events, for example providing a secondary game in which the player is given a chance to either double the award or lose the award.

The award may include the award of a feature game with pay characteristics that result in a positive value award, the actual value for a particular play of the feature game varying for each game play. Other awards may be able to be won, for example a jackpot, a progressive jackpot, or a fixed prize like a car. Some prizes may be awarded independent of the game outcome, for example based on the cumulative wagers placed on the gaming machine as in the case of a mystery jackpot, or based on an event having a probability related to the contribution to turnover on the gaming machine that a wager makes, as in the case of Aristocrat's Hyperlink™ system. After the award has been paid, then the process returns to step 1, via any other processes 6 that may be provided, which may be the same or different from the other processes provided when the game outcome is not associated with an award.

As will become apparent from the following description, embodiments of the invention involve variations to the structure of a typical pay table and typical game rules. In typical game rules, a player stakes a certain wager, for example 10 credits on each of 10 pay lines in a spinning reel game for a total wager of 100 credits. Alternatively and often substantially equivalently, the player may wager 10 credits on one pay line for 10 games, for total wager over the 10 games of 100 credits. In return, the player is given the chance to win one or more prizes as specified in the game pay table.

In this description of embodiments of the invention, the term ‘return’ has been used to refer to the average expected award from play of a wagering game. For example in a simple game with outcomes that occur with equal probability that provide awards of 0, 2 and 4, the return is 2. The term ‘return to player’ has been used to refer to the average expected net result when the wager staked to obtain the return is considered. For example, taking the same simple game, if the player was required to wager 3 credits to play the game, the return would be −0.33 for each credit wagered or 66%. Doubling the bet on an outcome of the game may result in a doubling of the return if the awards are doubled, but the return to player would remain constant.

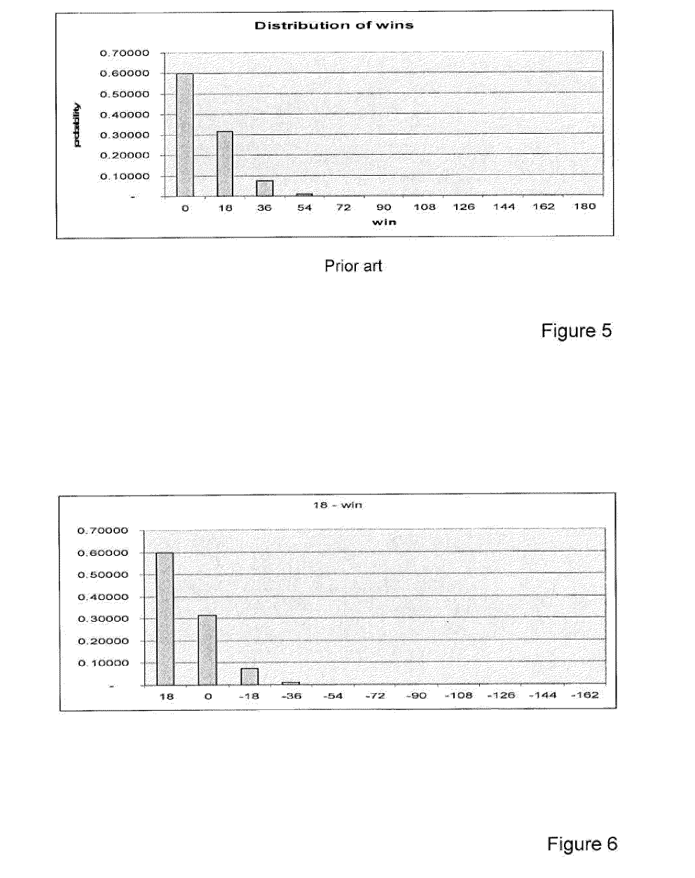

To achieve a return to player percentage below 100%, then on average, if a player wagered 100 credits, that player can expect to receive less than 100 credits in return. A typical distribution of wins and losses is shown in FIG. 5. For an example game in which 10 credits are wagered to purchase each game play, then the player can expect over 100 games:
60 games (a 0.60 probability) will be lost (i.e. result in an outcome that awards 0 credits);
32 games (a 0.32 probability) will result in an outcome that awards 18 credits;
6 games (a 0.06 probability) will result in an outcome that awards 36 credits; and
games (a 0.02 probability) will result in an outcome that awards 54 credits.

Therefore, the player can expect more than half, more particularly 60% of all credits wagered to award a win of zero, which is a loss of the wager. The expected return for all 100 games is 60×0+32×18+6×36+2×54=900. Because to play 100 games the player wagered 1000 credits, the expected return to player is 100 or 0.1 for each credit wagered. In other words, the return to player is 90%.

If the game rules allowed for a plurality of bets to be wagered on each outcome, then this would increase the return but not the expected return to player. For example if the player wagered 20 credits on each outcome for a total wager of 2000 credits across 100 game plays, then the expected return would be 1800, and the expected return to player is −200, which is also −0.1 for each credit wagered.

A gaming machine of the present invention provides for the possibility of the player receiving a negative payment, or penalty, upon the occurrence of certain negatively paying events in the game. Therefore, in step 1 the gaming machine 100 determines whether the player has sufficient credits in the credit meter 104 to cover the maximum negative payment that could eventuate. Alternatively, where a gaming venue provides credit facilities to its players, step 1 may involve determining whether there is sufficient value in the credit meter 104 or in available credit to cover the maximum negative payment that could eventuate. In addition, the player may be actively notified of the maximum possible loss for playing the game before step 2 commences.

Certain embodiments may not necessarily take any wager from the player before play of the game. In other embodiments the player may be able to bet in various unit amounts, with the effect of magnifying the possible wins and losses in the game. Losses and wins may be proportional to the units bet. This may just be a scalar multiplication of the entire game in the same sense as is true of the bet button on many previously known video poker machines. Alternatively an increased bet may increase the probability of a win, which is an alternative that has been used for progressive jackpots where the return is kept constant with respect to the wager size.

In still further embodiments the required wager to play a game may be negative. A negative wager is actually a payment to the player for playing the game. In one embodiment this negative wager is credited to the credit meters 104 upon initiation of the game play and before the outcome of the game is communicated to the player.

The award that is associated with the outcome of the game, which may be negative, is then awarded to the win meter and subsequently transferred to the credit meter, subject to variation by any intervening game events such as a ‘double or nothing’ feature. A ‘double or nothing’ feature implemented with the present invention may operate differently from typical features of this type. This is results from the potential for negative awards. For example, if the outcome of the game is a negative award of 10 credits, the player may given the chance to double the award or receive a zero award. In this case, a double award would result in an increased negative outcome of 20 credits and a zero award would represent a win from the ‘double or nothing’ feature. If the outcome of the game was a positive award of 10 credits, then achieving the ‘double’ result would be a winning outcome and the ‘nothing’ result a losing outcome, as is normal.

Intervening games may be provided other than a ‘double or nothing’ game. An example may be a game where the player gambles their positive or negative award on a card, dice or spinning reel game, with the chance to increase or decrease the award that they currently have in the win meter.

Referring to the main game (i.e. as opposed to an intervening game), by appropriate selection of the positive and negative payments, together with the required positive or negative wager, if any, required to play, the return to player of a game of the present invention can be designed to be mathematically equivalent to other typical wagering games. Existing games could be transformed into a game that plays in accordance with an embodiment of the present invention, with appropriate adaptation of the pay table and adaptation of the game rules if necessary.

In certain embodiments, the possibility of negative payments may be controlled by the player. This control may be achieved, for example, by the player specifying what wager they wish to stake. An example of this embodiment is provided in Example 1 herein below. Alternatively, a separate selection may be made, for example by the player operating the touch screen 107A or a button in the bank of buttons 107B, as to whether negative payments are possible, in which case the same value wager could result in different pay tables depending on the selection.

As will become apparent from the following description, embodiments of the present invention allow the most common result of a game to be one that gives an award greater than the return for the game. In some embodiments the most common award may also be greater than the amount wagered to play the game.

Some previously known games may have a component that has as the most common result an outcome that awards an amount greater than the return for the overall game or the amount wagered to play the game. For example a game may include a feature game component with these characteristics that is triggered on a random or quasi-random basis. Overall however, the most common result in the game is one that provides an award that is less than the return of the game, for example an award of zero credits. Embodiments described herein include games, which when considered overall, have as their most common result an award that is greater in value than the return for the game. Embodiments described herein also include games in which the most common result is greater than the wager required to play the game. The game may still retain a return to player less than 100%. These embodiments may or may not include feature games or other components that individually have a positive contribution to the return to player.

### Example 1

### A Dice Game

An example embodiment is in the form of a dice game where each side of the die occurs with equal probability. A range of wager options is provided from −5 through 0 to +5 and a listing of the prizes payable on each outcome of the dice game is provided in Table 1. Each wager option may represent a distinct game where only that wager option is available. Alternatively, the wager options may all be available in a single game, with the awards varying depending on what wager option is selected. The information in Table 1 forms part of the pay table 7 and is stored in the memory 103.

If the player wagers 1 credit upon the roll of a dice, then the prize listing specifies an award of 0 credits for dice results 1, 2, 3, 4, 5. This results in a loss of 1 credit to the player. An award of 5 credits is made for a dice result of 6. The return, which is calculated as sum of the awards that can be won divided by the number of possible game outcomes, is ⅚. The return to player, which is the return less the wager required to play the game, is −⅙ credits. Of course, if different outcomes occurred with different probability, then the calculation of the return would be weighted accordingly, for example as described herein in relation to the win distributions shown in FIGS. 5 and 6.

If the player wagers 0 credits to play the game, the (negative) award of −1 credit is awarded for dice results 1, 2, 3, 4 and 5, and 6 credits is awarded for a dice result of 6. This results in the same expected return to player of −⅙ credits. Table 1 shows the return and the return to player for all of the wager options −5 to +5, which all give a return to player of −⅙ credits.

In the leftmost column the player is paid 5 credits to play a game in which dice results from 1 to 5 award −6 credits (so that the net result is a deduction of 1 credit) and a 6 on the dice pays −1 credit (so that the net result is a payment of 1 credit). In the rightmost column 5 credits are wagered, in order to play a game with awards of 4 credits for dice results from 1 to 5 and an award of 9 credits for a dice result of 6. For each wager option, the awards are adjusted so as to create a different game that is mathematically equivalent in terms of return to player to the games played with the other wager options.

TABLE 1
Listing Of Prizes

| Dice roll | Wager | | | | | | |
|---|---|---|---|---|---|---|---|
| outcome | −5 | −3 | −1 | 0 | 1 | 3 | 5 |
| 1 | −6 | −4 | −2 | −1 | 0 | 2 | 4 |
| 2 | −6 | −4 | −2 | −1 | 0 | 2 | 4 |
| 3 | −6 | −4 | −2 | −1 | 0 | 2 | 4 |
| 4 | −6 | −4 | −2 | −1 | 0 | 2 | 4 |
| 5 | −6 | −4 | −2 | −1 | 0 | 2 | 4 |
| 6 | −1 | 1 | 3 | 4 | 5 | 7 | 9 |
| Return | −5.167 | −3.167 | −1.167 | −0.167 | 0.833 | 2.833 | 4.833 |
| Return | −0.167 | −0.167 | −0.167 | −0.167 | −0.166 | −0.167 | −0.167 |
| to player | | | | | | | |

This range of wager options is only one example of many possible variations. Other games may have only a selection of these wager options, for example −5, −3, 0, 3, 5. Other games may have different ranges of wager options, including only positive or only negative wagers. Other games may have only a single wager option.

Whether the wager is positive or negative, the wager has an immediate effect on the credit meters. Accordingly, the negative wagers are different from other payments in credits that a gaming machine makes, which are made to a win meter and then subsequently transferred to the credit meter.

The awards payable for each outcome of the game may also be varied. Table 1 shows a range of possibilities for different wager options, including all losing outcomes if a negative wager of 5 credits is made, all winning outcomes if a positive wager of 4 credits is made, and others with a mixture of winning and losing outcomes.

To provide variety, it is expected that having a mixture of winning and losing outcomes may be the most entertaining and therefore in some embodiments all wager options may have a mixture of winning and losing outcomes. To ensure equality between wager options, the awards are selected so that the return to player is the same, calculated as the average return across all possible outcomes of the game minus the wager staked to play the game.

### Example 2

A traditional game may involve a skewed distribution of results where the peak is below the mean. In other words, the average return is greater than what is most often achieved. In many games the average return is rarely exceeded. From the point of view of the player this result may be disappointing. An example win distribution of this type is shown in FIG. 5. A peak in the distribution occurs at an award of zero, which is well below the expected return of 9 credits.

If the pay table is modified so that a win of 18 credits is awarded instead of the award of zero credits and new negative wins are introduced, then the same return to player can be achieved. An example is shown in FIG. 6, which has the same win distribution as in FIG. 5, but with different awards. Over 100 games, the player can expect on average that:
60 games (a 0.60 probability) will result in an outcome that awards 18 credits;
32 games (a 0.32 probability) will result in an outcome that awards 0 credits;
6 games (a 0.06 probability) will result in an outcome that awards −18 credits; and
2 games (a 0.02 probability) will result in an outcome that awards −36 credits.

The most common result is now a positive outcome of 18 credits, which is balanced by the existence of some large losses among the possible results. In the example shown in FIG. 6, the awards have been selected to result in the same expected return of 9 credits per game play. In terms of return to player, the player over 100 games can expect to return 900 credits for the 1000 credits wagered, or −0.1 per credit.

The most common result of the game (18 credits) is a win that is larger than the wager staked to play the game (10 credits). This result is also larger than the return of the game (9 credits), in this example twice as large. This higher than average most common result may add interest for some players in comparison to the win distribution shown in FIG. 5, despite the equivalent expected return to player.

A most common result of an award worth more than 1.5 times the wager may provide particular entertainment to a player. In addition, a most common results that results in an award worth approximately 1.5 to 2 times the return of the game or more may provide particular entertainment to a player.

This example has been given with reference to a game that costs 10 credits to play. For example, in a spinning reel game with a single pay line on which the player can wager, then each spin of the reels will cost 10 credits. Other examples may require another wager amount to play, with appropriate modification of the magnitude of the awards for each available outcome.

### Example 3

Table 2 shows an example of a win distribution of a traditional style game with high awards of low probability and no award and small awards of high probability, together with another embodiment of a game including negative wins and having a win distribution to as to provide an above average win most of the time.

TABLE 2
win distribution of a traditional and negative win game

| | |
|---|---|
| Traditional game | Negative win game |

| probability | award | return | award | return |
|---|---|---|---|---|
| 0.1 | 50 | 5.0 | −26 | −2.6 |
| 0.2 | 20 | 4.0 | 4 | 0.8 |
| 0.3 | 10 | 3.0 | 14 | 4.2 |
| 0.4 | 0 | 0.0 | 24 | 9.6 |
| 1.0 | | 12.0 | | 12.0 |

The pay and return in the columns headed ‘Traditional game’ show a situation with large positive wins occurring with small probability and smaller wins and 0 results occurring with larger probabilities. This structure is common in traditional gaming machines. The return is 12 credits but a lesser result (either 10 credits or 0 credits) is achieved with high probability 0.7. The wager required to play each game may be set at 13 credits to maintain a negative return to player.

In the columns headed ‘Negative win game’, an award above return (14 or 24 credits) occurs more than half the time (0.3 and 0.4 probability respectively). More specifically, an award above return occurs with a probability of 0.7. As before, the return is maintained at 12 credits. In this example there is a 0.1 possibility of a negative award of −26 credits.

The gaming machine 100 may require that the player have 39 credits available before allowing play of the game, representing the maximum total loss that can occur in a single game play of the game.

### Example 4

Table 3 shows two examples of a game having a distribution of positive and negative wins that results in a negative return. The ‘Negative win game 1’ distribution may be suited to games that require a zero wager to play. The ‘Negative win game 2’ may be suited to games that require a negative wager to play, for example the player may be credited with 2 credits for each game that they play.

TABLE 3
win distribution of a negative win game

| | |
|---|---|
| Negative win game 1 | Negative win game 2 |

| probability | Award | return | Award | return |
|---|---|---|---|---|
| 0.1 | −50 | −5.0 | −50 | −5.0 |
| 0.2 | −15 | −3.0 | −30 | −6.0 |
| 0.3 | 5 | 1.5 | 0 | 0 |
| 0.4 | 16 | 6.4 | 20 | 8.0 |
| 1.0 | | −0.1 | | −3.0 |

Additional Features

Games that include negative wins may be combined with other features that are provided with games having a more traditional pay distribution.

For example, the games may fund a progressive jackpot. Taking for example the ‘Negative win game 2’ shown in Table 3, for each wager made, 0.9 credits may be added to a progressive win meter. This would result in a overall expected return of −0.1. Alternatively, a fixed prize worth $10,000 may be won by the gaming machine, or a gaming machine in a group of linked gaming machines with identical or substantially the same expected returns with a win probability of 0.009% for each game played.

A feature game may be provided, which then determines an award from the game. For example in the negative win game shown in Table 2, a feature game may be triggered on a symbol combination or other event that triggers a feature game may occur with a probability of 0.7. There could then be two results from the feature game, one awarding 14 credits and the other awarding 24 credits, with 24 credits being awarded in about 57% of the feature games.

Again referring to the negative win game shown in Table 2, an alternative feature game could occur with a probability of 0.50, in other words every second game. The feature game could then have two outcomes, one resulting in a negative award of −26 and the other resulting in an award of +24. The −26 award would occur in 20% of the feature games and the +24 award would occur in 80% of the feature games. A feature game presentation that depicts the player in a competition where the player can win or lose may be appropriate for a feature game that can result in either a positive or a negative award. The feature game may give the appearance that there is a skill component involved, for example by receiving a player input prior to showing the outcome of the game. The player input may be an attempt to stop a moving indicator in a particular location to achieve a win.

While the foregoing description has been provided by way of example of the preferred embodiments of the present invention as presently contemplated, which utilise gaming machines of the type found in casinos, those skilled in the relevant arts will appreciate that the present invention also may have application to internet gaming and/or have application to gaming over a telecommunications network, where handsets are used to display game outcomes and receive player inputs.

Where in the foregoing description reference has been made to integers having known equivalents, then those equivalents are hereby incorporated herein as if individually set forth. Those skilled in the relevant arts will also appreciate that modifications and additions to the embodiments of the present invention may be made without departing from the scope of the present invention.

It will further be understood that the invention disclosed and defined in this specification extends to all alternative combinations of two or more of the individual features mentioned or evident from the text or drawings. All of these different combinations constitute various alternative aspects of the invention.

1. A method of providing a wagering game implemented using a gaming machine, the method including determining an outcome of a game play of the wagering game, displaying representations of the outcome on a display of the gaming machine and awarding an award for the game play dependent on the determined outcome, wherein there are a plurality of different possible awards for the game play and at least one of the possible awards is a negative award, which results in a reduction in a credit balance in addition to any wager that may have been staked for the game play.

2. The method of claim 1 including providing the wagering game to have a return to player of less than 100% and so that the most common result for the determined outcome is the award of a said award that is greater than the return of the wagering game.

3. The method of claim 1, including providing the wagering game to have at least a 50% chance that the determined outcome results in the award of a said award that is greater than a wager staked to play the wagering game.

4. The method of claim 1, including allowing said game plays of the game to be played by staking a zero value wager.

5. The method of claim 1, further including determining whether there is sufficient credit available to cover the largest magnitude negative award possible in the game before allowing play of the wagering game.

6. The method of claim 1, wherein at least one of the possible awards has a value greater than or equal to twice the return of the wagering game.

7. The method of claim 1, wherein a positive value wager is required to play the game play and at least one of the possible awards has a value greater than or equal to twice the value of the wager.

8. The method of claim 1, wherein a positive value wager is required to play the game play and at least one of the possible awards has a value greater than or equal to five times the value of the wager.

9. The method of claim 1, wherein a positive value wager is required to play the game play and wherein the method includes providing the wagering game to have at least a 50% chance that the determined outcome results in the award of a said award that is greater than one and a half times the value of the wager and/or one and a half times the value of the return.

10. The method of claim 1, wherein a positive value wager is required to play the game play and wherein the method includes providing the wagering game to have at least a 50% chance that the determined outcome results in the award of a said award that is greater than twice the value of the wager and/or twice the value of the return.

11. A method of providing a wagering game implemented using a gaming machine, the method including determining an outcome of a game play of the wagering game, displaying representations of the outcome on a display of the gaming machine and awarding an award for the game play dependent on the determined outcome, wherein there are a plurality of different possible awards for the game play and at least one of the possible awards is a negative award, which results in a reduction in a credit balance, and wherein the method includes providing as at least one wager that is able to be staked in the game a negative value wager, which when staked results in an increase in value of a credit meter of the gaming machine.

12. The method of claim 11, including providing the wagering game to have a return to player of less than 100%.

13. The method of claim 12, wherein at least one of the possible awards that can result from the game play of the wagering game is a positive value award, which is awarded in addition to the value of the negative value wager staked to play the game play.

14. The method of claim 11, including awarding awards associated with outcomes of the game to a win meter and subsequently changing the value of the credit meter dependent on the value of the win meter.

15. The method of claim 14, including providing an intervening game event between awarding a said award to the win meter and changing the value of the credit meter dependent on the value of the win meter, the intervening event affecting the value in the win meter to increase to decrease the magnitude of the value in the win meter.

16. A gaming machine that provides a wagering game by determining an outcome of a game play of the wagering game, displaying representations of the outcome on a display and awards an award for the game play dependent on the determined outcome, wherein there are a plurality of different possible awards for the game play and at least one of the possible awards is a negative award, which results in a reduction in a credit balance in addition to any wager that may have been staked for the game play.

17. A gaming machine that provides a wagering game, the gaming machine including a game controller that determines an outcome of a game play of the wagering game, causes the display of representations of the outcome on a display and awards an award for the game play dependent on the determined outcome, wherein there are a plurality of different possible awards for the game play and at least one of the possible awards is a negative award, which results in a reduction in a credit balance and wherein a player is able to stake a zero-value wager to commence game play.

18. A gaming machine that provides a game in which a plurality of symbols are selected and presented on a display and if a winning combination occurs, the gaming machine awards an award, the gaming machine including a user interface in communication with a game controller that determines an outcome of a game play of the wagering game, displays representations of the outcome on the display and causes the award of an award dependent on the determined outcome, wherein there are a plurality of different possible awards for the game play and at least one of the possible awards is a negative award, which results in a reduction in a credit balance, and wherein a negative value wager is required to play a game play of the wagering game.

19. The gaming machine of claim 16, wherein the wagering game has a return to player of less than 100%.

20. The gaming machine of claim 16, wherein the gaming machine only allows game play if a current player of the gaming machine has sufficient credit to cover the maximum magnitude negative award that may result from the game play.

21. A gaming machine that provides a wagering game by determining an outcome of a game play of the wagering game, displaying representations of the outcome on a display and awards an award for the game play dependent on the determined outcome, wherein there are a plurality of different possible awards for the game play and at least one of the possible awards is a negative award, which is awarded to a win meter and which if transferred to the credit meter results in a reduction in a credit balance in addition to any wager that may have been staked for the game play and wherein the wagering game includes a further game event that affects the value held in the win meter after a said award has been made to the win meter.

22. The gaming machine of claim 21, wherein the further game event is a game, one outcome of which is an increase in the magnitude of a said negative award.

23. The gaming machine of claim 22, wherein one outcome of the further game event results in the win meter being given a value of zero.

24. The gaming machine of claim 21, wherein at least one of the possible awards for the game play is a positive award and the further game event affects the magnitude of a said negative of positive award that has been awarded to the win meter, but not whether it is negative or positive.

25. A gaming machine that provides a game in which a plurality of symbols are selected and presented on a display and if a winning combination occurs, the gaming machine awards an award, the gaming machine including a user interface in communication with a game controller that determines an outcome of a game play of the wagering game using one or more random numbers from a random number generator, controls the display to display representations of the outcome and causes the award of an award dependent on the determined outcome, wherein there are a plurality of different possible awards for the game play and at least one of the possible awards is a negative award, which results in a reduction in a credit balance in addition to any wager that may have been staked for the game play, and the method includes providing the wagering game to have a return to player of less than 100% and to have at least a 50% chance that the determined outcome results in the award of a said award that is greater than the return of the wagering game.

26. The method of claim 1, including instructions for a computational device stored in memory in communication with the computational device or as part of the computational device, wherein the instructions cause the computation device to perform the method.
